(19) United States
(12) Patent Application Publication
(10) Pub. No.: US 2005/0031882 A1
(43) Pub. Date: Feb. 10, 2005

(54) Biodegradable coated substrates

(75) Inventors: Isao Noda, Fairfield, OH (US); Michael Matthew Satkowski, Oxford, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/930,024

(22) Filed: Aug. 30, 2004

Related U.S. Application Data
(63) Continuation of application No. 10/309,990, filed on Dec. 4, 2002, now abandoned.
Application No. 10/309,990 is a continuation of application No. PCT/US01/18746, filed on Jun. 8, 2001.
(60) Provisional application No. 60/210,618, filed on Jun. 9, 2000.

(51) Int. Cl. G03C 7/32

(52) U.S. Cl. 428/500; 428/511; 428/526

(57) ABSTRACT

Coated substrates include a coating and a substrate is selected from the group consisting of paper, fabric, thread and yarn. The coating comprises a biodegradable polyhydroxyalkanoate copolymer, wherein the biodegradable polyhydroxyalkanoate copolymer comprises a first randomly repeating monomer unit having the structure: 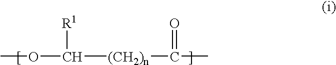
wherein R¹ is H or a C₁₋₂ alkyl, and n is 1 or 2; and a second randomly repeating monomer unit having the structure: 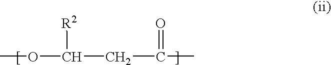
wherein R² is a C₃₋₁₉ alkyl or a C₃₋₁₉ alkenyl; and wherein at least 50% of the randomly repeating monomer units have the structure of the first randomly repeating monomer unit.

### CROSS REFERENCE TO RELATED APPLICATION

This application is a continuation of International Application PCT/US01/18746, with an international filing date of Jun. 8, 2001, and published in English, which claims the benefit of U.S. Provisional Application No. 60/210,618, filed Jun. 9, 2000.

### TECHNICAL FIELD

This invention relates to substrates having a coating comprising biodegradable plastics. More particularly, this invention relates to substrates having a coating comprising biodegradable polyhydroxyalkanoate copolymers.

### BACKGROUND ART

Polymers find uses in a variety of plastic articles including films, sheets, fibers, foams, molded articles, adhesives and many other specialty products. The majority of this plastic material ends up in the solid waste stream. While some efforts at recycling have been made, repeated processing of even pure polymers results in degradation of material and consequently poor mechanical properties. Different grades of chemically similar plastics mixed upon collection can cause processing problems that make the reclaimed material inferior or unusable. Thus, there is a need for plastics, including plastic coatings, which are biodegradable.

Items such as juice boxes or foil food containers often are formed with laminates of plastics or foil. As such laminates often comprises non-biodegradable matters, these items must be removed from the stream of food waste and deposited in landfills. Thus, there is a need for coatings which are biodegradable and yet resistance to grease and water. Additionally, glossy finishes are often desired on paper products, such as printing or wrapping paper. Thus, there is a need for coatings which are biodegradable and yet provide a glossy finish to paper.

Jaschek et al., U.S. Pat. No. 4,405,341, disclose a coated fabric consisting of continuous multi-filament threads chemically activated and roughened to improve adhesion coated with two layers of coatings comprise a mix of a dispersable elastic and/or thermoplastic substance with a highly cross-linked duroplastic substance.

Smith, U.S. Pat. No. 4,632,874, discloses a substantially homogenous aqueous composition for imparting coherency to textile filaments and textile yarns, comprising an emulsifiable textile finishing oil and a water dissipatable polymer. Smith teaches that filaments of any yarn must to some degree have coherency to prevent the filaments or fibers from becoming tangle masses.

Dahmen et al., U.S. Pat. No. 4,774,131, disclose a process for the production of a textile surface coated with polyurethane, comprising wet coating the textile materials with an aqueous cationic dispersion of a polyurethane with covalently bonded, solubility-enhancing cationic groups and an aqueous, anionic dispersion of a polyurethane with covalently bonded, solubility-enhancing, anionic groups. Dahmen et al. teach that textiles are useful for the production of breathable and water-proof clothing, and subsequently drying the coated material, the improvement which comprises applying to the textile surface.

Van Gompel, U.S. Pat. No. 4,797,171, discloses a method of making a coated fabric comprising providing a base ply of non-woven fiber material; forming in the base ply material a pattern of densified and undensified portions, the densified portions extending to at least one surface, designated the coating surface; then providing a thermoplastic film in a heat-softened condition; contacting the heat-softened thermoplastic film with the coating surface of the base ply; controlling the depth of penetration of the heat-softened thermoplastic film to a depth less than the entire depth of the base ply by maintaining the temperature of the film and the contact pressure between the film and the base ply at predetermined values, and allowing the surface coating of film to cool.

Malhotra, U.S. Pat. No. 5,075,153, discloses a coated paper comprising a plastic supporting substrate, a binder layer composed of polymer selected from the group consisting of hydroxypropylcellulose, poly(vinyl alkylether), vinyl pyrrolidone/vinyl acetate, quaternized vinyl pyrrolidone/dialkylaminoethyl/methylacrylic, pyrrolidone/dialkylaminoethyl/methylacrylic, poly(vinyl pyrrolidone), poly(ethylene imine), and mixtures thereof, a pigment or pigments, and an ink receiving polymer layer. Malhotra teaches the supporting substrate may be a polyester.

Doran, U.S. Pat. No. 5,194,322, discloses a coated textile material comprising a textile substrate having a microporous coating of an elastomeric copolymer wherein at least one component thereof is a fluorocarbon, wherein the coating is formed as a compressed foam layer at the surface of the textile substrate, the layer being compressed on the surface and set to form a coherent coarse membrane.

Pommeranz et al., U.S. Pat. No. 5,306,544, disclose a paper web for producing trays or coasters comprising a hygroscopic support paper and a sliding reducing means on one side wherein the sliding reducing means includes a coating forming a discrete structure on the support paper and consisting of butylacrylate and methylacrylamide.

Di Mino, U.S. Pat. No. 5,470,594, discloses a recyclable pouch for packaging food products comprising two superposed plies, each formed by at least one sheet of paper, each ply having an interface coated with a layer of water-based acrylic polymer having a low glass transition temperature and an outer face coated with a water-based acrylic polymer having a relatively high glass transition temperature, the superposed plies being sealed together in a pre-determined sealing pattern by heat and pressure which brings about fusion of the inner layer. Di Mino teaches each ply may be composed of two sheets of paper which are laminated with a water-based acrylic adhesive. Di Mino further teaches that the nature of the adhesive and the acrylic layers is such that the paper pouch lends itself to being recycled.

Quick et al., U.S. Pat. No. 5,763,100, teach a recyclable paper stock comprising a substrate coated on at least one surface with a water-based emulsion coating, the coating consisting essentially of 20 to 90 dry weight percent of an acrylic-styrene copolymer which consists essentially of acrylic monomers and styrene having a glass transition temperature below 50° C.; 5 to 70 dry weight percent of a wax component selected from the group consisting of paraffin wax, microcrystalline wax, polyethylene wax, and blends of two or more of the waxes; and an acrylic polymer having a glass transition temperature above 30° C. present in amount up to 60 dry weight percent, wherein the coating forms a water-resistant film on the substrate surface.

Finestone et al., U.S. Pat. No. 5,786,064, disclose a paper-film laminate sheeting comprising a paper ply having top and bottom surfaces, a reinforcing ply of a synthetic plastic film material having top and bottom surfaces, a water-based adhesive layer for laminating the bottom surface of the paper ply to the top surface of the reinforcing ply, and fiberglass strands between the paper and reinforcing plies to increase the strength of the sheeting, wherein the top surface of the film is activated by corona discharge treatment prior to contact by the adhesive, and the sheeting includes a plurality of minute pores which are uniformly distributed throughout. Finestone et al. teach the laminate sheeting is permeable only to moisture vapor, and can be tailored to form water-proof yet breathable garments.

Nielsen et al., U.S. Pat. No. 5,795,320 disclose an applicator comprising a tubular member formed from a single layer of paper having an exterior surface, and a coating applied to the exterior surface, the coating being a single layer of compostable material and comprising at least 85% by weight of a polylactide polymeric material, at least 10% by weight of additives, and up to 5% by weight of a residual monomer, wherein the coating provides the tubular member with a dry coefficient of kinetic friction value ranging from between 0.62 to 0.86. Nielsen et al. teach the paper applicator which has a compostable coating on its external surface closely approximates the esthetic appearance of a plastic applicator and has a lower coefficient of friction than a plastic applicator.

El-Afandi et al., U.S. Pat. No. 5,849,401, disclose a compostable multi-layer film comprising a core layer comprising a lactic acid residue-containing polymer, and a first and second blocking reducing layers comprising a semi-crystalline aliphatic polyester. El-Afandi et al. teach that the compostable multi-layer structures are films having desirable properties of flexibility and tear resistance and can be used to provide disposable bags.

Bloch et al., U.S. Pat. No. 5,962,099, disclose a pressure sensitive sealing tape consisting essentially of a thin biaxially oriented synthetic-plastic film ply formed of a material selected from the group consisting of polypropylene, polyethylene and polyester, a paper ply cold laminated by water-based adhesive to the film ply, and a layer of pressure sensitive adhesive coating one side of the laminate, and a release agent coating the other side of the laminate to prevent blocking.

Unfortunately, many prior art plastic items comprise plasticizers. Additionally, many prior service items paper or plastic bags are lacking in strength or have poor water permeation resistance and/or grease permeation resistance. Further, many biodegradable plastic items are brittle, or are incapable of degrading under both aerobic and anaerobic conditions.

Additionally, prior art polymers such as polyhydroxybutyrate and polyhydroxy-butyrate-co-valerate often have unsatisfactory properties. Polyhydroxybutyrate and polyhydroxybutyrate-co-hydroxyvalerate tends to become thermally unstable near their is melt temperatures which make processing difficult. It is preferred that the melting temperature of a biodegradable material be substantically lower that its decomposition temperature, or the temperature at which molecular weight substantially decreases due to hydrolysis.

There is a need for polymers which are strong without being brittle, which are easy to process and which will biodegrade under both aerobic and anaerobic conditions. Further, there is a need for coatings which improve the water and grease resistance of paper and fabric, and will can impart a gloss to paper.

### SUMMARY OF THE INVENTION

Accordingly, it is an object of this invention to obviate various problems of the prior art.

It is also object of this invention to provide coated substrates which can be anaerobically degraded without harm to the ecosystem.

It is another object of this invention to provide coated paper and coated fabric which have good water and grease resistance characteristics. As used herein, “liquid resistance” and “grease resistance” refer to the ability of an item to resist penetration or leakage by liquid and grease, respectively.

It is yet another object of this invention to provide biodegradable coated substrates which are substantially free of phthalate plasticizers.

It is another object of this invention to provide biodegradable coated substrates from biodegradable polymers which are easily processed.

It is yet another object of this invention to provide biodegradable coated paper which has a glossy surface.

In accordance with one aspect of the invention there are provided coated substrates comprising a substrate and a coating. The coating comprises a biodegradable polyhydroxyalkanoate copolymer, comprising a first randomly repeating monomer unit having the structure: 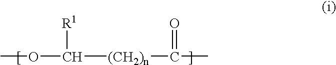
wherein R¹ is H or a C₁₋₂ alkyl, and n is 1 or 2; and a second randomly repeating monomer unit having the structure: 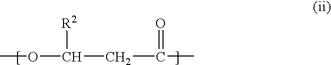
wherein R² is a C₃₋₁₉ alkyl or a C₃₋₁₉ alkenyl; and wherein at least 50% of the randomly repeating monomer units have the structure of the first randomly repeating monomer unit. The substrate is selected from the group consisting of paper, fabric, thread and yarn.

In accordance with another aspect of the invention there are provide methods of improving the resistance to grease of a substrate, comprising the step of applying a coating to a substrate selected from the group consisting of paper, fabric, thread and yarn. The coating comprises a biodegradable polyhydroxyalkanoate copolymer comprising two randomly repeating monomer units wherein the first randomly repeating monomer unit has the structure: 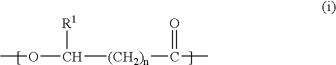
wherein R¹ is H or a C₁₋₂ alkyl, and n is 1 or 2; and, the second randomly repeating monomer unit has the structure: 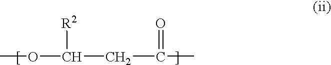
wherein R² is a C₃₋₁₉ alkyl or a C₃₋₁₉ alkenyl; and wherein at least 50% of the randomly repeating monomer units have the structure of the first randomly repeating monomer unit.

In accordance with yet another aspect of the invention there are provide methods of improving the resistance to water of a substrate, comprising the step of applying a coating to a substrate selected from the group consisting of paper and fabric. The coating comprises a biodegradable polyhydroxyalkanoate copolymer comprising two randomly repeating monomer units wherein the first randomly repeating monomer unit has the structure: 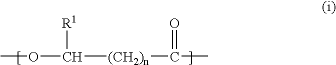
wherein R¹ is H or a C₁₋₂ alkyl, and n is 1 or 2; and the second randomly repeating monomer unit has the structure: 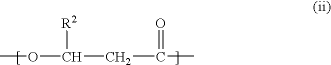
wherein R² is a C₃₋₁₉ alkyl or a C₃₋₁₉ alkenyl; and wherein at least 50% of the randomly repeating monomer units have the structure of the first randomly repeating monomer unit.

In accordance with yet another aspect of the invention there are provide methods of providing a gloss on paper, comprising the step of applying a coating to the paper, wherein the coating comprises a biodegradable polyhydroxyalkanoate copolymer, comprising two randomly repeating monomer units wherein the first randomly repeating monomer unit has the structure: 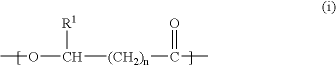
wherein R¹ is H or a C₁₋₂ alkyl, and n is 1 or 2; and the second randomly repeating monomer unit has the structure: 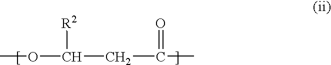
wherein R² is a C₃₋₁₉ alkyl or a C₃₋₁₉ alkenyl; and wherein at least 50% of the randomly repeating monomer units have the structure of the first randomly repeating monomer unit. The coating improves the resistance to water of the item and is capable of aerobic and anaerobic degradation.

### DETAILED DESCRIPTION OF THE INVENTION

As used herein, “PHA” refers to a polyhydroxyalkanoate polymer of the present invention. Applicants have found that compositions comprising polyhydroxyalkanoate polymers (PHAs) provide useful coatings for substrates such as paper, fabric, thread and yarn. PHAs in accordance with the present invention will biodegrade under both aerobic and anaerobic conditions, thus, items formed from the PHAs can biodegrade even when under water. The PHAs may be disposed of into the food waste stream as a mixture of food waste and PHAs, for example, food waste and paper substrates having a coating comprising PHA may be composted together. Biodegradation of the PHAs will occur without harm to the environment, microorganisms or animals.

Biodegradable items in accordance with the invention are unexpectantly resistant to liquids and grease. The items are formed from PHAs exhibit surprisingly good heat-sealability and adhesion to paper substrates.

Further, unlike the homopolymer poly(3-hydroxybutyrate) (PHB) or the copolymer poly(3-hydroxybutyrate-co-3-hydroxyvalerate) (PHBV), PHAs in accordance with the invention are tough without being brittle. Thus items comprising the PHAs are less likely to crack or delaminate. Applicants have found that polyhydroxyalkanoates in accordance with the present invention have lower melt temperatures, lower degrees of crystalinity and improved melt rheologies relative to polyhydroxybutyrate and poly(3-hydroxybutyrate-co-3-hydroxyvalerate). As the PHAs of the present invention have low melting temperatures, the PHAs can be processed into films and coatings. The PHAs of the present invention have melting temperatures lower than their decomposition temperatures, or the temperature at which substantial MW loss due to hydrolysis occurs.

As used herein, the term “coating” is intended to refer to both a layer exclusively on the surface of a substrate as well as a layer which to some degree penetrates the substrate. Suitable substrates include paper, fabric, thread and yarn. Often the substrate will be paper. As used herein, “paper” refers to a substrate formed from cellulose fiber, including paper and cardboard. As used herein, “fabric” includes natural and synthetic fabrics. The fabrics may be knitted, woven or non-woven. Suitable fabrics include cotton, rayon, wool, and polyesters, as well as biodegradable fabrics comprising PHAs. As used herein, “thread and yarn” includes natural and synthetic threads and yarns, such as cotton, rayon, polyester, wool, silk, nylon, and acrylic as well as biodegradable threads and yarns comprising PHAs. Thread and yarn may be formed using fibers of PHA. As used herein, “fiber” refers to a flexible, macroscopically homogeneous body having a high length-to-width ratio and a small cross section.

A coating comprising PHA improves the water and grease resistance substrates, and provides the substrate with a smoother surface. The coating may be applied to one or two sides of a substrate such as paper or fabric.

Coated paper may be used as backing for tape; preferably the tape comprises paper, a coating comprising PHA and an adhesive, preferably an adhesive comprising PHA.

Fabric and paper coated with PHA can be used to form items with improved water and grease resistance, such as wrapping paper, paper bags, plastic bags, cardboard containers, drink boxes, trays, table clothes, napkins, rain coats and ponchos, and disposable garments such as surgical scrubs. Thread and yarn coated with PHA have a smoother surface than untreated thread or yarn, and are less likely to tangle. Disposable garment seams may be sewn with thread, preferably a PHA-coated thread, or may be joined with an adhesive, preferably a biodegradable adhesive comprising a PHA.

As used herein, “RRMU” refers to a randomly repeating monomer unit and “RRMUs” refers to randomly repeating monomer units. As used herein, “alkyl” refers to a saturated carbon-containing chain which may be straight or branched, and substituted (mono- or poly-) or unsubstituted, while, “alkenyl” refers to a carbon-containing chain which may be mono-unsaturated (i.e., one double bond in the chain) or poly-unsaturated (i.e., two or mor double bonds in the chain), straight or branched, and substituted (mono- or poly-) or unsubstituted.

As used herein, “biodegradable” refers to the ability of a compound to ultimately be degraded completely into CH₄, CO₂ and water or biomass by microorganisms and/or natural environmental factors.

As used herein, “compostable” refers to a material that meets the following three requirements: (1) the material is capable of being processed in a composting facility for solid waste; (2) if so processed, the material will end up in the final compost; and (3) if the compost is used in the soil, the material will ultimately biodegrade in the soil.

For example, a polymer film material present in solid waste submitted to a composting facility for processing does not necessarily end up in the final compost. Certain composting facilities subject the solid waste stream to air classification prior to further processing, in order to separate paper and other materials. A polymer film would most probably be separated from the solid waste stream in such an air classification and therefore not be processed in the composting facility. Nevertheless, it may still be a “compostable” material according to the above definition because it is “capable” of being processed in a composting facility.

The requirement that the material ends up in the final compost typically means that it undergoes a form of degradation in the composting process. Typically, the solid waste stream will be subjected to a shredding step in an early phase of the composting process. As a result, the polymer film will be present as shreds rather than a sheet. In the final phase of the composting process, the finished compost will be subjected to a screening step. Typically, the polymer shreds will not pass through the screens if they have retained the size they had immediately after the shredding step. The compostable materials of the present invention will have lost enough of their integrity during the composting process to allow partially degraded shreds to pass through the screens. However, it is conceivable that a composting facility might subject the solid waste stream to a very rigorous shredding and a rather coarse screening, in which case nondegradable polymers like polyethylene would meet requirement (2). Therefore, meeting requirement (2) is not enough for a material to be compostable within the present definition.

What distinguishes the compostable material as defined herein from material like polyethylene is requirement (3), that the material ultimately biodegrade in the soil. This biodegradability requirement is not essential to the composting process or the use of composting soil. Solid waste and the compost resulting therefrom may contain all kinds of nonbiodegradable materials, for example, sand. However, to avoid a build up of man-made materials in the soil, it is required herein that such materials be fully biodegradable. By the same token, it is not at all necessary that this biodegradation be fast. As long as the material itself and intermediate decomposition products are not toxic or otherwise harmful to the soil or crops, it is fully acceptable that their biodegradation takes several months or even years, since this requirement is present only to avoid an accumulation of man-made material in the soil.

All copolymer composition ratios recited herein refer to molar ratios, unless specifically indicated otherwise. All percentages and parts are by weight, unless specifically indicated otherwise.

The polyhydroxyalkanoates used in the present invention made be synthetically prepared, or may be produced by a variety of biological organisms, such as bacteria or algae. The polyhydroxyalkanoates may be atactic, isotactic or syndiotactic. The polyhydroxyalkanoates used herein are preferably substantially isotactic (from about 90% to about 100%, by weight, isotactic) or fully isotactic (about 100%, by weight, isotactic). The fully isotactic polyhydroxyalkanoates may be obtained from biological organisms, preferably polyhydroxyalkanoates used herein are obtained from biological organisms.

The polyhydroxyalkanoates are copolymers comprising at least about 2 different monomers. In some embodiment, the polyhydroxyalkanoates are copolymers comprising at least about 3 different monomers.

In one embodiment, the polyhydroxyalkanoate comprises at least two randomly repeating monomer units (RRMUs). The first randomly repeating monomer unit has the structure: 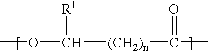
wherein R¹ is H or a C₁₋₂ alkyl, and n is 1 or 2. In a preferred embodiment, the first randomly repeating monomer unit is selected from the group consisting of the monomer wherein R¹ is a C₁ alkyl and n is 1 (the monomeric repeat unit 3-hydroxybutyrate); the monomer wherein R¹ is a C₂ alkyl and n is 1 (the monomeric repeat unit 3-hydroxyvalerate); the monomer wherein R¹ is H and n is 2 (the monomeric repeat unit 4-hydroxybutyrate); the monomer wherein R¹ is H and n is 1 (the monomeric repeat unit 3-hydroxypropionate); and mixtures thereof.

The second randomly repeating monomer unit has the structure: 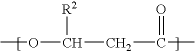
wherein R² is a C₃₋₁₉ alkyl or a C₃₋₁₉ alkenyl. Suitable second RRMUs include those wherein R² is a C₃₋₇ alkyl or alkenyl, a C₅ alkyl or alkenyl, a C₇ alkyl or alkenyl, a C₈₋₁₁ alkyl or alkenyl, a C₈ alkyl or alkenyl, a C₉ alkyl or alkenyl, a C₁₂₋₁₉ alkyl or alkenyl, a C₃₋₁₁ alkyl or alkenyl, or a C₄₋₁₉ alkyl or alkenyl.

Suitable polyhydroxyalkanoates include poly(3-hydroxybutyrate-co-3-hydroxyhexanoate)s (PHB-Hxs) and poly(3-hydroxybutyrate-co-3-hydroxyoctanoate)s (PHB-Os). In one embodiment, the coating comprises a polyhydroxyalkanoates selected from the group consisting of poly(3-hydroxybutyrate-co-3-hydroxyhexanoate) 12.1% hexanoate (PHB-Hx 12.1%), poly(hydroxybutrate-co-hydroxyhexanoate) 11.1 mol % hexanoate (PHB-Hx 11%), poly(3-hydroxybutyrate-co-3-hydroxyoctanoate) 8.4% octanoate (PHB-0 8.4%), poly(3-hydroxy butyrate-co-3-hydroxyoctanoate) 13% octanoate (PHB-0 13%).

In one embodiment of the present invention, at least about 50%, preferably at least about 60%, more preferably at least about 70%, even more preferably at least about 80%, more preferably still at least about 85%, of the RRMUs have the structure of the first RRMU.

When one or more of the polyhydroxyalkanoates of the present invention are processed into films or sheets preferably from about 70% to about 99%, more preferably from about 80% to about 95%, even more preferably from about 85% to about 92%, of the RRMUs of the PHA have the structure of the first RRMU.

In one embodiment the films or sheets are solution cast films or sheets. Generally from about 70% to about 99%, preferably from about 80% to about 95%, more preferably from about 85% to about 92%, of the RRMUs of the PHAs used to prepare solution cast films or sheets have the structure of the first RRMU.

In one embodiment the films or sheets are melt pressed films or sheets. Generally from about 70% to about 99%, preferably from about 80% to about 95%, more preferably from about 85% to about 92%, of the RRMUs of the PHAs used to prepare melt pressed films or sheets have the structure of the first RRMU.

When one or more of the polyhydroxyalkanoates of the present invention are processed into coating compositions, generally from about 75% to about 95%, preferably from about 80% to about 92%, more preferably from about 85% to about 90%, of the RRMUs of the PHAs have the structure of the first RRMU.

In one embodiment, the coating composition is in the form of a solution comprising PHA. The solution further comprises a solvent in which the PHA is soluble, such as CHCl₃, ethylactelate, acetone, toluene and mixture thereof. Generally from about 75% to about 95%, preferably from about 80% to about 92%, more preferably from about 85% to about 90%, of the RRMUs of the PHAs used to form the solution have the structure of the first RRMU.

In one embodiment, the coating composition is in the form of a dispersion comprising PHA. The solution further comprises a solvent in which the PHA forms a suspension, such as hexane, ethanol, methanol, mineral oil and water. Generally from about 75% to about 95%, preferably from about 80% to about 92%, more preferably from about 85% to about 90%, of the RRMUs of the PHAs used to form the suspension have the structure of the first RRMU.

In one embodiment, the coating composition is in the form of an aqueous slurry comprising PHA. Generally from about 80% to about 95%, preferably from about 82% to about 92%, more preferably from about 85% to about 90%, of the RRMUs of the PHAs used to form the slurry have the structure of the first RRMU.

When the polyhydroxyalkanoates of the present invention are processed soft elastic fibers, preferably from about 50% to about 98%, more preferably from about 80% to about 97%, even more preferably from about 85% to about 96%, of the RRMUs of the PHAs have the structure of the first RRMU.

When the polyhydroxyalkanoates of the present invention are processed into normal fibers, preferably from about 80% to about 99%, more preferably from about 90% to about 98%, even more preferably from about 95% to about 97%, of the RRMUs of the PHAs have the structure of the first RRMU.

When the polyhydroxyalkanoates of the present invention are processed into elastomers or an adhesives, such as bandage adhesives, preferably about 50% more preferably at least 65% of the RRMUs of the PHAs have the structure of the first RRMU.

When the polyhydroxyalkanoates of the present invention are processed into nonwoven fabrics, preferably from about 85% to about 99%, more preferably from about 90% to about 98%, even more preferably from about 95% to about 97%, of the RRMUs of the PHAs have the structure of the first RRMU.

In a preferred embodiment, the first randomly repeating monomer unit is selected from the group consisting of the monomer wherein R¹ is a C₁ alkyl and n is 1 (the monomeric repeat unit 3-hydroxybutyrate); the monomer wherein R¹ is a C₂ alkyl and n is 1 (the monomeric repeat unit 3-hydroxyvalerate); the monomer wherein R¹ is H and n is 2 (the monomeric repeat unit 4-hydroxybutyrate); the monomer wherein R¹ is H and n is 1 (the monomeric repeat unit 3-hydroxypropionate); and mixtures thereof.

In another embodiment, the polyhydroxyalkanoate of the present invention comprises a third or more additional RRMUs having the structure: 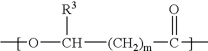
wherein R³ is H, a C₁₋₁₉ alkyl or a C₁₋₁₉ alkenyl, and m is 1 or 2; and wherein the additional RRMUs are not the same as the first RRMU or the second RRMU. In one embodiment the copolymer comprises from at least about 3, more preferably from about 3 to about 20 different RRMUs.

In one embodiment, R³ is a C₁₋₁₉ alkyl or a C₁₋₁₉ alkenyl, and m is 1, while in another embodiment R³ is a H, a C₁₋₂ alkyl or a C₁₋₂ alkenyl, and m is 1 or 2. In a preferred embodiment, the third RRMU is selected from the group consisting of the monomer wherein R³ is a C₁ alkyl and m is 1 (the monomeric repeat unit 3-hydroxybutyrate); the monomer wherein R³ is a C₂ alkyl and m is 1 (the monomeric repeat unit 3-hydroxyvalerate); the monomer wherein R³ is H and m is 2, (the monomeric repeat unit 4-hydroxybutyrate); the monomer wherein R³ is H and m is 1, (the monomeric repeat unit 3-hydroxypropionate) and mixtures thereof.

In another embodiment a polyhydroxyalkanoate according to the present invention comprises two RRMUs wherein the first RRMU has the structure: 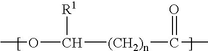
wherein R¹ is H or a C₂ alkyl, and n is 1 or 2; and the second RRMU has the structure: 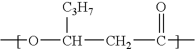
Preferably at least about 50% of the RRMUs have the structure of the first RRMU.

The one embodiment a polyhydroxyalkanoate according to the present invention comprises three RRMUs, a first RRMU having the structure: 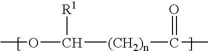
wherein R¹ is H or a C₁₋₂ alkyl, and n is 1 or 2; a second RRMU having the structure: 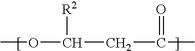
wherein R² is a C₃₋₁₉ alkyl or a C₃₋₁₉ alkenyl, preferably a C₄₋₁₉ alkyl or a C₄₋₁₉ alkenyl; and a third RRMU having the structure: 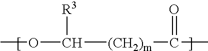
wherein R³ is H, a C₁₋₁₉ alkyl or a C₁₋₁₉ alkenyl, and m is 1 or 2; and wherein the third RRMU is not the same as the first RRMU or the second RRMU. Preferably at least 50% of the RRMUs have the structure of the first RRMU.

Preferably, the molecular weight of the polyhydroxyalkanoates is greater than about 25,000. In one embodiment the weight average molecular weight is no greater than about 400,000. In another embodiment the weight average molecular weight is greater than about 400,000, preferably greater than 500,000.

The volume percent crystalinity (Φ_{c}) of a semi-crystalline polymer (or copolymer) often determines what type of end-use properties the polymer possesses. For example, highly (greater than 50%) crystalline polyethylene polymers are strong and stiff, and suitable for products such as plastic cups. Low crystalline polyethylene, on the other hand, is flexible and tough, and is suitable for products such as bags. Crystalinity can be determined in a number of ways, including x-ray diffraction, differential scanning calorimetry (DSC), density measurements, and infrared absorption, as discussed by Noda, U.S. Pat. No. 5,618,855, incorporated herein by reference.

In general, PHAs of the present invention preferably have a crystalinity of from about 0.5% to about 95% as measured via x-ray diffraction; more preferably from about 10% to about 80%; more preferably still from about 20% to about 60%.

When a PHA of the present invention is to be processed into a film, the amount of crystalinity in such PHA is more preferably from about 2% to about 65% as measured via x-ray diffraction; more preferably from about 5% to about 50%; more preferably still from about 20% to about 40%.

When a PHA of the present invention is to be processed into a sheet, the amount of crystalinity in such PHA is more preferably from about 0.1% to about 50% as measured via x-ray diffraction; more preferably from about 5% to about 50%; more preferably still from about 20% to about 40%.

When a PHA of the present invention is to be processed into a coating composition in the form of a solution, the amount of crystalinity in such PHA is more preferably from about 15% to about 60% as measured via x-ray diffraction; more preferably from about 20% to about 50%; more preferably still from about 30% to about 40%.

When a PHA of the present invention is to be processed into a coating composition in the form of a suspension, the amount of crystalinity in such PHA is more preferably from about 15% to about 60% as measured via x-ray diffraction; more preferably from about 20% to about 50%; more preferably still from about 30% to about 40%.

When a PHA of the present invention is to be processed into a coating composition in the form of a slurry, the amount of crystalinity in such PHA is more preferably from about 15% to about 60% as measured via x-ray diffraction; more preferably from about 20% to about 50%; more preferably still from about 30% to about 40%.

When a PHA of the present invention is to be processed into a normal fiber or a nonwoven fabric, the amount of crystalinity in such PHA is more preferably from about 50% to about 95% as measured via x-ray diffraction; more preferably from about 60% to about 95%; more preferably still from about 70% to about 95%.

When a PHA of the present invention is to be processed into a soft elastic fiber, the amount of crystalinity in such PHA is more preferably from about 20% to about 90% as measured via x-ray diffraction; more preferably from about 30% to about 85%; more preferably still from about 40% to about 80%.

When a PHA of the present invention is to be processed into an elastomer or adhesive, the amount of crystalinity in such PHA is more preferably less than about 50% as measured via x-ray diffraction; more preferably less than about 30%; more preferably still less than about 20%.

Preferably, the biodegradable PHAs of the present invention have a melt temperature (Tm) of from about 30° C. to about 160° C., more preferably from about 60° C. to about 140° C., more preferably still from about 90° C. to about 130° C.

Suitable polyhydroxyalkanoates include those disclosed in Noda, U.S. Pat. Nos. 5,498,692; 5,502,116; 5,536,564; 5,602,227; 5,618,855; 5,685,756; and 5,747,584, incorporated herein by reference.

The coatings may serve as barriers, decorative coatings, or for other purposes. Coating may be used to apply adhesive for laminating one web to another or for manufacturing of pressure-sensitive tapes and labels. It also may be used for saturation of a porous web substrate, such as paper, in order to improve its resistance to moisture or grease penetration, or to improve its strength.

The thickness of a coating is generally measured in “mils”. One mil is equal to 0.001 inch. The substrates generally have a coating up to 5, preferably from about 4 to about 0.5, more preferably from about 2 to about 1 , mils thick. Paper substrates generally have a coating with a thickness of from about 5 to about 0.5, preferably from about 2 to e.g., about 1, mils, while fabric substrates generally have a coating with a thickness of from about 5 to about 1, preferably from about 3 to about 2, mils. Thread and yarn substrates generally have a thinner coating than paper or fabric substrates, such as a thickness of from about 2 to about 0.2, preferably from about 1 to about 0.5, mils.

The coatings may comprise additives such as colorants. Preferably, such colorants are nonfugitive. As used herein, “nonfugitive” refers to an additive that does not escape from the polyhydroxyalkanoate copolymer at a faster rate than which the copolymer biodegrades. The coatings herein may be formed from a composition comprising the biodegradable polyalkanoate copolymer and colorant. Alternatively, colors and designs may be printed on the items after manufacture. Preferably the colorants are non-toxic. Some items, such as garbage bags, may have coatings comprising deodorants, fragrances or disinfectants.

Many plastic items comprise plasticizers such as phthalate plasticizers or adipic acid derivatives such as di-2 ethyl hexyl adipate. Phthalate plasticizers refer to compounds comprising a phthalate group used as plasticizers. Such plasticizers include bis-2-ethylhexyl phthalate, also referred to as dioctyl phthalate (DOP) and di-2-ethylhexyl phthalate (DEHP), and diisononyl phthalate (DINP). Other phthalate plasticizers include butyl benzyl phthalate, butyl octyl phthalate, di-n-butyl phthalate, dicapryl phthalate, dicyclohexyl phthalate, diethyl phthalate, dihexyl phthalate, diisobutyl phthalate, diisodecyl phthalate, diisohectyl phthalate, diisooctyl phthalate, dimethyl phthalate, ditridecyl phthalate, diundecyl phthalate, undecyl dodecyl phthalate and mixtures thereof.

However, there is concern that plasticizers, particularly phthalate plasticizers may leach from plastic items. Thus, in one embodiment the coatings and coated substrates are preferably substantially free of, more preferably free of, plasticizers, particularly phthalate plasticizers. As used herein, substantially free of means preferably no greater than 20%, more preferably no greater than 10%, even more preferably less than 5%, by weight, of the item is plasticizers.

In another embodiment, the coatings and coated substrates may contain plasticizers, preferably non-toxic and biodegradable plasticizers. Suitable plasticizers include tricarboxylic esters, citrate esters, esters of glycerine and dicarboxylic esters. A preferred plasticizer is triacetin, also called glyceryl triactetate or 1,2,3-propanetriol triacetate. Generally, coatings containing plasticizers comprises from about 40% to about 3%, preferably from about 20% to about 5%, by weight of total coating, plasticizer, and from about 59% to about 96%, preferably from about 79% to about 94%, by weight of total coating, PHA. In one embodiment the coating comprises a polyhydroxyalkanoate in accordance with the invention, triacetin, and polyhydroxybutyrate (PHB), in a weight ratio of from about 50% to 95% PHA, 45% to 4% triaretin, 5% to 1% PHB, more preferred 70-92% PHA, 26 to 7% plasticizer, 4% to 1% PHB. Most preferred about 85:13:2 PHA:plastizer:PHB. Suitable polyhydroxyalkanoates include poly(3-hydroxybutyrate-co-3-hydroxyhexanoate) (PHB-Hx) and poly(3-hydroxybutyrate-co-3-hydroxyoctanoate) (PHB-O).

In one embodiment of the invention, coated substrates comprise a coating comprising a biodegradable polyhydroxyalkanoate comprising at least two randomly repeating monomer units. In one embodiment the PHA comprises a first randomly repeating monomer unit having the structure: 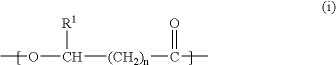
wherein R¹ is H or a C₁₋₂ alkyl, and n is 1 or 2; and a second randomly repeating monomer unit having the structure: 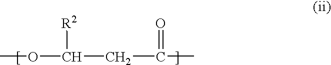
wherein R² is a C₃₋₁₉ alkyl or a C₃₋₁₉ alkenyl, preferably a C₄₋₁₉ alkyl or a C₄₋₁₉ alkenyl.

In another embodiment the polyhydroxyalkanoate comprises a third randomly repeating monomer unit having the structure: 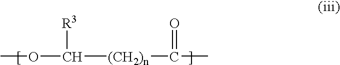
wherein R³ is H, a C₁₋₁₉ alkyl or a C₁₋₁₉ alkenyl, and m is 1 or 2, and the third RRMU is not the same as the first RRMU or the second RRMU. Polyhydroxyalkanoate copolymers comprising three RRMUs will generally comprise, by weight, at least about 50% of the first RRMU, and generally no greater than about 20% of the third RRMU. The composition may comprise at least about 4%, more preferably at least about 5%, and even more preferably at least about 8%, and no more than about 15%, preferably no more than about 12%, more preferably no more than about 10%, by weight, of the third RRMU. The preferred levels of monomers is dependent upon the desired characteristic of the article, for example, when using a rigid substrate, such as paper, a thicker or stiffer coating may be desired than when using a flexible substrate, such as fabric.

The PHAs used as coatings preferably comprise a first RRMU having formula (i) above, and a second RRMU having formula (ii) above. Preferably the weight average of molecular weight of the copolymer is greater than 50,000, preferably greater than about 100,000. In one embodiment the PHAs used as coatings comprise from about 4% to about 20%, preferably at least about 5%, by weight of total PHA, of the third RRMU having the formula (iii) above.

Coated articles may be formed using any conventional coating techniques or coating equipment. Coating techniques include extrusion coating, roller coating, brush coating, dip coating, spray coating, electrostatic coating, centrifugal coating and cast coating. Articles may be coated with melted PHA, and then exposed to a coolant, such as water, by any acceptable method, such as dipping or spraying. Substrates may be laminated with a sheet or film comprising PHA, such as a solution cast film or a melt pressed film. Slurries, suspensions or solutions comprising PHA may be applied to a substrate, and the substrate then allowed to dry and, optionally, pressed.

Coatings applied in a non-solid form must be sufficiently fluid to be spread into a uniformly thin layer across the substrate. Therefore, coatings are applied as solutions in organic solvents, as aqueous solutions or emulsions, as a hot melt (solid molten or softened by heat), or as a reactive liquid that solidifies by a polymerization reaction induced either thermally or by radiation. Extrusion coating, is similar to hot-melt coating.

In extrusion coating, a film of molten polymer is deposited between two moving webs in a nip created by a rubber pressure roll and a chrome-plated steel chill roll. In this continuous operation, rolls of material are unwound, new rolls are automatically spliced on the fly, and the surface of the substrate is prepared by chemical priming or other surface treatment to make it receptive to the extrusion coating, and to help develop adhesion between the two materials.

Coatings may be applied directly to the substrate, or may be cast to another surface, dried, and later transferred to the substrate. This transfer coating process is used for manufacturing of, for example, pressure-sensitive label stock: the adhesive is first applied to a silicone-coated release liner, dried, and then laminated to the label face stock. Coatings may be applied to the web material wound in rolls, or to precut sheets. Items such as disposable plates and trays may be formed by pressing coated paperboard blanks between forming dies, as disclosed in Shanton, U.S. Pat. No. 5,776,619, incorporated herein by reference.

In one embodiment, films or sheets comprising a PHA are used to laminate a substrate, such as paper. As used herein, “film” means an extremely thin continuous piece of a substance having a high length to thickness ratio and a high width to thickness ratio. While there is no requirement for a precise upper limit of thickness, a preferred upper limit is about 0.254 mm, more preferably about 0.10 mm, and even more preferably about 0.05 mm. As used herein, “sheet” means a very thin continuous piece of a substance, having a high length to thickness ratio and a high width to thickness ratio, wherein the material is thicker than about 0.254 mm. Sheeting shares many of the same characteristics as film in terms of properties and manufacture, with the exception that sheeting is stiffer, and has a self-supporting nature.

Articles comprising PHAs, such as sheets and films, may be made by any art-recognized process, such as those disclosed in Noda, U.S. Pat. Nos. 5,618,885 and 5,602,227, incorporated herein by reference. For example, films may be processed using conventional procedures for producing single or multilayer films on conventional film-making equipment. Sheets may be thermoformed. As used here, “thermoforming” refers to a process by which planks or sheets of the polyhydroxyalkanote are heated until flexible and then stamped or vacuum pulled into the proper shape. Generally a sheet is fed through an oven and heated to bring it to a thermoformable temperature. The sheet is heated to a softening point and then advanced to a forming station. Alternatively, a sheet may move directly from an extruder to a forming station by means of a series of rolls, which can either be heated or cooled to bring the sheet to the proper thermoforming temperature. The forming station comprises molds or stamps of the desired shapes.

Several preferred embodiments are illustrated in the following non-limiting examples.

### EXAMPLE 1

### Printed Paper Coated with a Laminated Layer of poly(3-hydroxybutyrate-co-3-hydroxyhexanoate) Polymer

A film of poly(3-hydroxybutyrate-co-3-hydroxyhexanoate) 12.1% hexanoate (PHB-Hx 12.1%) is prepared from extrusion from the melt. The neat PHB-Hx powder is run through a Haake single screw extruder fitted with a strand die at 130° C. The strand is run through a water bath at a temperature of 60 C. The strand is run through Berlyn pelletizer to create pellets. The pellets are fed into a hopper of the Haake single screw extruder with a 6 inch flat die. The screw barrel and die temperatures are set at 150 C. The film is taken up with Haake cast film haul off unit, with release paper separating the PHA film layers in the roll to prevent blocking. The film has a nominal thickness of 2 mil. The film is cut into sheets that are approximately 10 inches long and 4 inches wide. The film sheet is placed on top of common copier paper (Georgia Pacific Spectrum DP white), so placed to cover one half of the paper sheet surface. The sheet assembly is placed between release paper (Idesco) and fed into an 8″ laminator (Idesco model 7000) operating at 85 C. The sheet is allowed to cool. The resulting coated paper is then fed into a Xerox 5750 laser printer by placing it the normal paper tray. A test image is printed on the paper. The resulting image is clear and the toner is fused securely to the coated side. The coated surface is glossier than the uncoated surface, and the image appears sharper to the eye than the uncoated part of the paper.

### EXAMPLE 2

### Wrapping Paper Coated with a Laminated Layer of poly(3-hydroxybutyrate-co-3-hydroxyhexanoate)/Plasticizer Blend

A film of a blend of poly(3-hydroxybutyrate-co-3-hydroxyhexanoate) 12.1 % hexanoate, (PHB-Hx 12.1%)/Triacetin/polyhydroxybutyrate (PHB) in proportion of 85/12/3 is prepared from extrusion from the melt. The neat PHB-Hx power, PHB powder, and triacetin is run through a Haake twin screw extruder fitted with a strand die at 150 C. The strand is run through a water bath at a temperature of 40 C. The strands run through a Berlyn pelletizer to create pellets. The pellets are fed into a hopper of a Haake single screw extruder with 6 inch flat die. The screw barrel and die temperatures are set 130 C. The film is taken up with Haake cast film haul-off unit, with release paper separating the PHA film layers to prevent blocking. The film has a nominal thickness of 2-4 mil. The film is cut into sheets that are approximately 10 inches long and 4 inches wide. The film sheet is placed on top of common copier paper (Georgia Pacific Spectrum DP white), so placed to cover one half of the paper sheet surface. The sheets assembly is placed between release paper (Idesco) and is fed into an eight inch laminator (Idesco model 7000) operating at 85 C. The sheet is allowed to cool. The paper is then fed into a Xerox 5750 laser printer, placed in the normal paper tray. A test pattern is printed on the paper. The resulting image is clear and the toner is fused securely to the coated side of the paper. The coated surface is glossier than the uncoated surface and the pattern appears sharper to the eye than the uncoated part of the paper.

### EXAMPLE 3

### Wrapping Paper Coated with a poly(hydroxybutrate-co-hydroxyhexanoate) Polymer via a Liquid Suspension

An emulsion of PHA is prepared in the following manner. 5 g of poly(hydroxybutrate-co-hydroxyhexanoate) 11.1 mol % hexanoate (PHB-Hx 11%) is dissolved in 45 g acetone at 50 C until the solution is completely clear. The solution is precipitated by slow addition of excess methanol (ca. 5×) and forms a precipitate. The dry precipitate is then ground with a Wiley mill grinder until a fine (ca. 30mesh) powder is obtained. The powder is resuspended in 45 g of hexane. The suspension is stirred with a magnetic stirrer.

A frame is placed on the paper to be coated (Georgia Pacific Spectrum DP white). The frame is about 12 cm wide by 20 cm inches tall by 0.5 mm in height and serves to allow a particular amount of suspension to be placed on the paper. Approximately 120 ml of the mixture is poured in the frame and excess emulsion is removed by running a steel bar over the top of the frame. The sheet is allowed to dry in a hood. The paper is then placed in a Carver press between sheets of release paper and pressed at 80 C at 5000 lb. for 60 seconds. The paper is removed and allowed to cool. The paper is then fed into a Xerox 5750 laser printer. A test pattern is printed on the paper. The resulting pattern is sharp and clear the toner is fused securely to the coated side. The coated surface is glossy and the image appears sharper to the eye than the uncoated part of the paper.

### EXAMPLE 4

### Melt-coated Paper with Poly(3-hydroxybutyrate-co-3-hydroxyoctanoate) (PHB-O)

Films of poly(3-hydroxybutyrate-co-3-hydroxyoctanoate) (PHB-O) are made in the following manner. About 2.5 grams of Poly(3-hydroxybutyrate-co-3-hydroxyoctanoate) (8.4%) octanoate content are placed between two 0.25 mm thick Teflon sheets into a brass shim of thickness 4 mil. The Teflon, shim and polymer are placed between steel plates and heat pressed in a Carver press (Menomonee Falls, Wis.) at 145 C at 5000 lb. force for not longer than 3 minutes. The polymer and Teflon sheets are then removed and placed between 2 kg steel plates for at least 20 minutes to quickly crystallize film at the ambient temperature (25° C.). In this way, 12 cm square films of PHB-O of thickness 4 mil can be made. Coated papers are made by placing the film sheet on top of common copier paper (Georgia Pacific Spectrum DP white). The film and paper is placed between release paper (Idesco) and fed into an 8″ laminator (Idesco model 7000) operating at 85 C. The sheet is allowed to cool. The resulting coated paper is then fed into a Xerox 5750 laser printer by placing it the normal paper tray. A test image is printed on the paper. The resulting image is clear and the toner is fused securely to the coated area.

### EXAMPLE 5

### Coating of Poly(3-hydroxybutyrate-co-3-hydroxyoctanoate) on Paper

In order to make a coating, 0.3 g of Poly(3-hydroxybutyrate-co-3-hydroxyoctanoate) 8.4% octanoate (PHB-O 8.4) is dissolved in 9 ml of CHCl₃ at 50 C until the solution is clear. A Teflon sheet placed over a 5 kg aluminum plate. The sample of paper to be coated is placed over Teflon sheet and a 8 cm diameter glass cylinder is placed on the paper. The paper in this case is Georgia Pacific Spectrum DP white. The solution is then poured into the glass cylinder and allowed to evaporate slowly at room temperature for 12 hours. After twelve hours the glass cylinder is removed, the paper coating is smoothed by pressing in a Carver Press for 140° C. at 2000 lb. for 30 sec.

The coating is impervious to water and can be printed on with a laser printer such as a Hewlett Packard laser jet 5C.

### EXAMPLE 6

### Coating of Paper from a Slurry of poly(hydroxybutrate-co-hydroxyhexanoate)

A slurry of poly(hydroxybutrate-co-hydroxyhexanoate) (PHB-Hx) was prepared by adding approximately 20 g PHB-Hx (11.1% in powder form with 100 g of ice in a Waring blender. The mixture was stirred for 20 minutes in a Waring blender at its maximum rpm. The resultant pulverized powder of PHA is mixed into water in at about 25% weight PHA, and the slurry is deposited on a sheet of paper (George pacific DP white). A small frame of 1 inch wide by 4 inches long by ¼ inch deep is placed on the paper and the slurry is poured into the frame. After the slurry is dried, the powder PHA coating on the paper is fixed by placing the sheet of paper between release paper sheets and inserting the assembly into a laminator (Idesco) operating at 85° C. The coated segment of paper can be printed on by placing the sheets in a Xerox 5750 laser printer and printing a test pattern on the coated part. The toner is fused securely to the coating. The coating also resists penetration to grease and water. If a small amount (10 ml) of water or canola oil is placed on the coated side of the paper, the paper does not discolor from the water or oil.

### EXAMPLE 7

### Printed Paper Coated with a Laminated Layer of poly(3-hydroxy butyrate-co-3-hydroxyoctanoate) PHB-O Polymer

A film of poly(3-hydroxy butyrate-co-3-hydroxyoctanoate) 13% octanoate, (PHB-O 13%) is prepared from extrusion from the melt. The neat PHB-O powder is run through a Haake single screw extruder fitted with a strand die at 130° C. The strand is run through a water bath at a temperature of 60° C. The strand is run through Berlyn pelletizer to create pellets. The pellets are fed into a hopper of the Haake single screw extruder with a 6 inch flat die. The screw barrel and die temperatures are set at 145° C. The film is taken up with Haake cast film haul off unit, with release paper separating the PHA film layers in the roll to prevent blocking. The film has a nominal thickness of 1-2 mil. The film is cut into sheets that are approximately 10 inches long and 4 inches wide. The film sheet is placed on top of common copier paper (Georgia Pacific Spectrum DP white), so placed to cover one half of the paper sheet surface. The sheets assembly is placed between release paper (Idesco) and fed into an 8″ laminator (Idesco model 7000) operating at 85° C. The sheet is allowed to cool. The resulting coated paper is then fed into a Xerox 5750 laser printer by placing it the normal paper tray. A test image is printed on the paper. The resulting image is clear and the toner is fused securely to the coated side. The surface is glossier than the uncoated side and the image appears sharper to the eye than the uncoated part of the paper.

### EXAMPLE 8

### Printed Paper Coated with a Laminated Layer of poly(3-hydroxy butyrate-co-3-hydroxyoctanoate Polymer Produced from Solution Cast Film

A film of poly(3-hydroxy butyrate-co-3-hydroxyoctanoate (13% octanoate), PHB-O 13% is prepared from casting from acetone. Approximately 5 g of the neat PHB-O powder is dissolved in 200 ml of acetone at 50° C. The solution is stirred for at least three hours until the solution is clear. The solution is then poured into circular shallow Teflon dish approximately 5 inches in diameter. The dish is placed in a oven, an the solvent is allowed to evaporate slowly overnight (10-12 hours) to produce a transparent film. The film has a nominal thickness of 1-2 mil. The film sheet is placed on top of common copier paper (Georgia Pacific Spectrum DP white), so placed to cover one half of the paper sheet surface. The sheets assembly is placed between release paper (Idesco) and fed into an 8″ laminator (Idesco model 7000) operating at 85° C. The sheet is allowed to cool. The resulting coated paper is then fed into a Xerox 5750 laser printer by placing it the normal paper tray. A test image is printed on the paper. The resulting image is clear and the toner is fused securely to the coated side. The surface is glossier than the uncoated side and the image appears sharper to the eye than the uncoated part of the paper.

### EXAMPLE 9

### Fabric Laminated with a Layer of poly(3-hydroxy butyrate-co-3-hydroxyoctanoate Polymer Produced from Solution Cast Film

A film of 13% octanoate, (PHB-O 13%) is prepared from casting from acetone. Approximately 5 g of the neat PHB-O powder is dissolved in 200 ml of acetone at 50° C. The solution is stirred for at least three hours until the solution is clear. The solution is then poured into circular shallow Teflon dish approximately 5 inches in diameter. The dish is placed in a oven, an the solvent is allowed to evaporate slowly overnight (10-12 hours) to produce a transparent film. The film has a nominal thickness of 1-2 mil. The film sheet is placed on top of a 5 inch square section of untreated cotton fabric. The assembly is placed between release paper (Idesco) and placed into a Carver Press preheated to 100 C. The fabric/PHA assembly is pressed for 20 seconds at 1000 lbs. The resulting coated fabric is then removed from the press and allowed to cool. The fabric is then subjected to the following test to check for grease resistance and water resistance. About 20 ml of canola oil is placed on the PHA coated side of the fabric and allowed to remain for 1 hour. The fabric is free of oil stains that would indicate penetration of the oil. About 20 ml of tap water is placed on the PHA coated side of the fabric and allowed to remain for 1 hour. The fabric is free of darkening that would indicate penetration of the water.

### EXAMPLE 10

### Fabric Laminated with a Layer of poly(3-hydroxybutyrate-co-3-hydroxyhexanoate) Polymer Produced from Melt Pressed Film

A film of poly(3-hydroxybutyrate-co-3-hydroxyhexanoate) 11.1% hexanoate (PHB-Hx-11.1%) is prepared by placing 5 g of powder of the PHB-Hx between two Teflon sheets then inserting this in a Carver press preheated to 140 C. The PHB-Hx is pressed at approximately 7,000 lb. force for 2 minutes. The PHB-Hx is removed from the press and allowed to cool. The PHB-Hx is now in the form of a film sheet of about 3 mil thickness. The film sheet is placed on top of a 5 inch square section of untreated cotton fabric. The assembly is placed between release paper (Idesco) and placed into a Carver Press preheated to 100° C. The fabric/PHA assembly is pressed for 20 seconds at 1000 lbs. The resulting coated fabric is then removed from the press and allowed to cool. The fabric is then subjected to the following test to check for grease resistance and water resistance. About 20 ml of canola oil is placed on the PHA coated side of the fabric and allowed to remain for 1 hour. The fabric is free of oil stains that would indicate penetration of the oil. About 20 ml of tap water is placed on the PHA coated side of the fabric and allowed to remain for 1 hour. The fabric is free of darkening that would indicate penetration of the water.

Additional embodiments and modifications within the scope of the claimed invention will be apparent to one of ordinary skill in the art. Accordingly, the scope of the present invention shall be considered in the terms of the following claims, and is understood not to be limited to the details or the methods described in the specification.

1-20. (canceled)

21. A coated substrate comprising a substrate and a coating comprising a biodegradable polyhydroxyalkanoate copolymer, wherein the biodegradable polyhydroxyalkanoate copolymer comprises a first randomly repeating monomer unit having the structure: 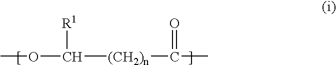
wherein R¹ is H or a C₁₋₂ alkyl, and n is 1 or 2; and a second randomly repeating monomer unit having the structure: 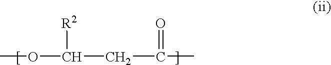
wherein R² is a C₄₋₁₉ alkyl or a C₄₋₁₉ alkenyl; and wherein at least 50% of the randomly repeating monomer units have the structure of the first randomly repeating monomer unit, and wherein the substrate is selected from the group consisting of paper, fabric, thread and yarn.

22. A coated substrate according to claim 21, wherein the biodegradable polyhydroxyalkanoate copolymer further comprises a third randomly repeating monomer unit having the structure: 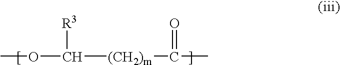
wherein R³ is H, a C₁₋₁₉ alkyl or a C₁₋₁₉ alkenyl, and m is 1 or 2; and wherein the third randomly repeating monomer unit is not the same as the first randomly repeating monomer unit or the second randomly repeating monomer unit.

23. A coated substrate according to claim 21, wherein R¹ is a C₁₋₂ alkyl and n is 1.

24. A coated substrate according to claim 21, wherein R¹ is H and n is 2.

25. A coated substrate according to claim 21, wherein the coating is substantially free of plasticizers.

26. A method of improving the resistance to grease of a substrate, comprising the step of applying a coating to a substrate selected from the group consisting of paper, fabric, thread and yarn, wherein the coating comprises a biodegradable polyhydroxyalkanoate copolymer comprising two randomly repeating monomer units wherein the first randomly repeating monomer unit has the structure: 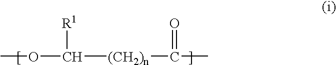
wherein R¹ is H or a C₁₋₂ alkyl, and n is 1 or 2; and the second randomly repeating monomer unit has the structure: 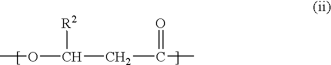
wherein R² is a C₄₋₁₉ alkyl or a C₄₋₁₉ alkenyl; and
wherein at least 50% of the randomly repeating monomer units have the structure of the first randomly repeating monomer unit.

27. A method according to claim 26, wherein the biodegradable polyhydroxyalkanoate copolymer further comprises a third randomly repeating monomer unit having the structure: 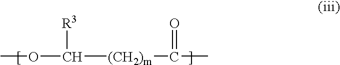
wherein R³ is H, a C₁₋₁₉ alkyl or a C₁₋₁₉ alkenyl, and m is 1 or 2; and wherein the third randomly repeating monomer unit is not the same as the first randomly repeating monomer unit or the second randomly repeating monomer unit.

28. A method according to claim 26, wherein R¹ is a C₁₋₂ alkyl and n is 1.

29. A method according to claim 28, wherein R¹ is a C₁ alkyl.

30. A method according to claim 26, wherein R¹ is H and n is 2.

31. A method of coating a substrate, comprising the step of applying a coating to the substrate, wherein the coating comprises a biodegradable polyhydroxyalkanoate copolymer comprising two randomly repeating monomer units wherein the first randomly repeating monomer unit has the structure: 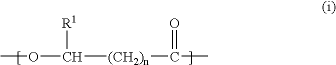
wherein R¹ is H or a C₁₋₂ alkyl, and n is 1 or 2; and the second randomly repeating monomer unit has the structure: 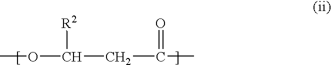
wherein R² is a C₄₋₁₉ alkyl or a C₄₋₁₉ alkenyl; and wherein at least 50% of the randomly repeating monomer units have the structure of the first randomly repeating monomer unit, and wherein the substrate is selected from the group consisting of paper and fabric.

32. A method according to claim 31, wherein the step of applying the coating to the substrate comprises laminating the substrate with a film comprising the biodegradable polyhydroxyalkanoate copolymer.

33. A method according to claim 32, wherein the film is a solution cast film.

34. A method according to claim 32, wherein the film is a melt pressed film.

35. A method according to claim 31, wherein the step of applying the coating to the substrate comprises:
(a) preparing a coating composition comprising polyhydroxyalkanoate copolymer;
(b) applying the coating composition to the substrate to obtain a coated substrate; and
(c) allowing the coated substrate to dry.

36. A method according to claim 35, further comprising the step subjecting the substrate to pressure.

37. A method according to claim 35, wherein the coating composition is a solution.

38. A method according to claim 35, wherein the coating composition is a slurry.

39. A method according to claim 35, wherein the coating composition is a suspension.

40. A method according to claim 31, wherein the step of applying the coating to the substrate comprises extrusion coating the substrate.
